(19) United States
(12) Patent Application Publication
(10) Pub. No.: US 2010/0097197 A1
(43) Pub. Date: Apr. 22, 2010

(54) HEALTHCARE INDUSTRY PILLOW SPEAKER CABLES AND INTERFACES

(75) Inventor: Mark Sowada, Montrose, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: CREST ELECTRONICS, INC., Dassel, MN (US)

(21) Appl. No.: 12/533,276

(22) Filed: Jul. 31, 2009

Related U.S. Application Data
(60) Provisional application No. 61/086,297, filed on Aug. 5, 2008.

(51) Int. Cl. G08B 5/22; H04R 9/06; H02G 5/00; B23P 11/00

(52) U.S. Cl. 340/286.07; 381/333; 174/71 B; 29/428

(57) ABSTRACT

Healthcare industry pillow speaker cables and interfaces are disclosed. Pillow speaker cables communicatively couple a pillow speaker to another device. Pillow speaker cables comprise four wires. The first wire and the second wire comprise a data bus for communicating data to and from the pillow speaker. The third wire and the fourth wire comprise an audio line and an audio return line for transmitting audio information to and from a speaker in the pillow speaker.

### REFERENCE TO RELATED CASE

The present application is based on and claims priority of U.S. provisional patent application Ser. No. 61/086,297, filed Aug. 5, 2008, the content of which is hereby incorporated by reference in its entirety.

### BACKGROUND

Audio signal are commonly transmitted across a distance. For instance, in a short-term or long-term care facility, a patient or resident may be in a room with a television. In such a case, it may be desirable to transmit the television's audio output to a location closer to the patient or resident where it can be converted to sound. Generating the sound closer to the resident or patient may make listening to the sound more convenient and may also reduce overall noise levels that could disturb others (e.g. a patient or resident in a neighboring room).

### SUMMARY

An aspect of the disclosure relates to pillow speaker cables and interfaces for the healthcare industry. In one embodiment, a pillow speaker cable for communicatively coupling a pillow speaker to another device comprises four wires. The first wire and the second wire comprise a data bus for communicating data to and from the pillow speaker. The third wire and the fourth wire comprise an audio line and an audio return line for transmitting audio information to and from a speaker in the pillow speaker.

These and various other features and advantages that characterize the claimed embodiments will become apparent upon reading the following detailed description and upon reviewing the associated drawings.

### BRIEF DESCRIPTION OF THE DRAWINGS

FIG. 1 is a schematic diagram of a wireless audio system.

FIG. 2-1 is a perspective view of wireless audio system transmitter arrays.

FIG. 2-2 is a top down view of wireless audio system transmitter arrays.

FIG. 3 is a block diagram of a wireless audio system transmitter.

FIG. 4 is a block diagram of a wireless audio system receiver.

### DETAILED DESCRIPTION

Certain embodiments of the present disclosure include systems and methods of wirelessly transmitting and receiving an audio signal. In one embodiment, a wireless signal is transmitted across an indirect path. For example, a wireless signal is generated and transmitted by a transmitter and is then reflected off from one or more surfaces or objects before reaching a receiver. This indirect transmission may be advantageous over other systems such as systems that require a direct line-of-sight between a transmitter and a receiver. For instance, in a line-of-sight system, a signal may be blocked from reaching a receiver if an object passes between the transmitter and the receiver. Also, in a line-of-sight system, the physical positioning or placement of the receiver and transmitter are commonly limited. For example, the receiver may need to be positioned at a certain angle or height relative to the transmitter to receive a signal. In at least some embodiments of the present disclosure, the indirect transmission of signals allows for a signal to travel around an object that passes between the transmitter and receiver, and allows for the signal to successfully reach the receiver. Similarly, the indirect transmission of signals illustratively allows for greater flexibility in the positioning of the receiver relative to the transmitter. For instance, a receiver could be positioned such that its sensor faces away from the transmitter. The receiver illustratively receives a signal by receiving a signal that has been reflected from its original direction to the direction of the receiver's sensor.

Certain embodiments of the present disclosure illustratively provide additional benefits such as, but not limited to, reduced power consumption, improved system troubleshooting and set-up capabilities, improved signal transmission interfaces, and enhanced operational capabilities (e.g. the ability to operate multiple wireless systems in one room). These and other advantages and benefits will become apparent in the following more detailed description of embodiments.

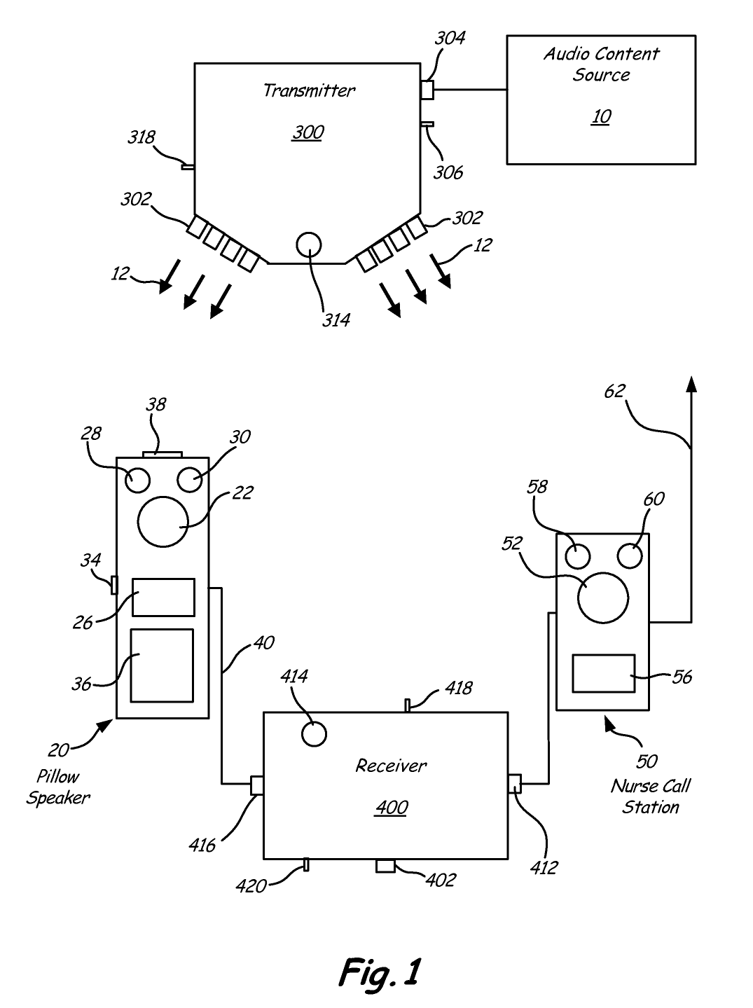

FIG. 1 is a block diagram of an illustrative wireless audio system. The audio system includes a transmitter 300 that receives an audio signal from an audio content source 10. Audio source 10 includes any type of device that produces an audio signal. Illustrative audio sources include, but are not limited to, televisions, computers, media players (e.g. an optical media player), and video game systems. As will be described in greater detail later, transmitter 300 converts an audio signal received from source 10 into a wireless signal 12 that is transmitted to receiver 400. Receiver 400 converts the wireless signal back into an audio signal and illustratively relays the audio signal to pillow speaker 20. Pillow speaker 20 has a speaker 22 that utilizes the audio signal to generate sound that can be listened to by a user.

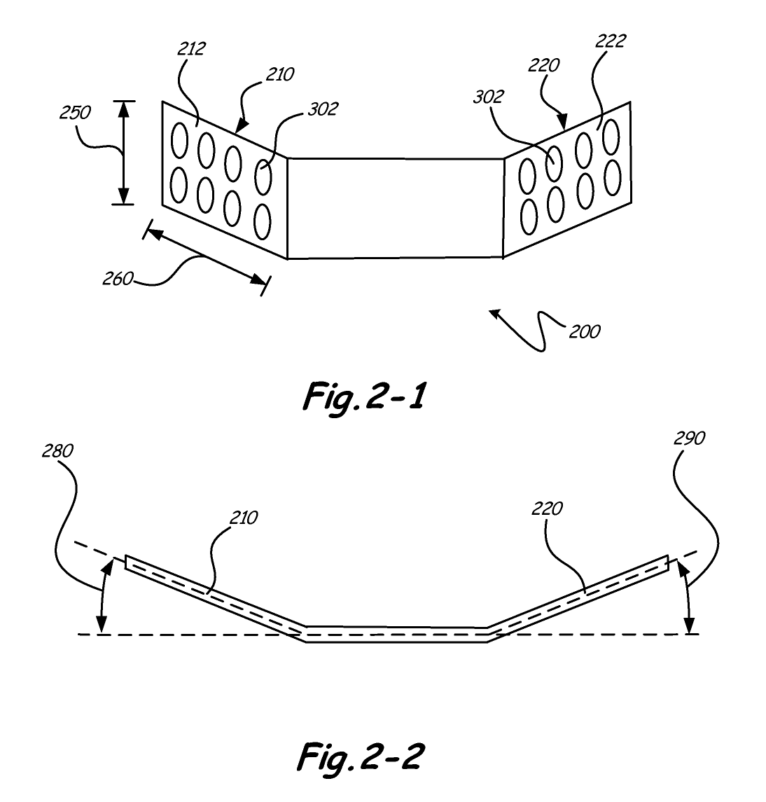

In an embodiment, wireless signal 12 comprises infrared (IR) light produced by one or more transmitter light emitting diodes (LEDs) 302. In single LED embodiments, the single LED is illustratively a relatively powerful LED in that it is capable of generating enough light to essentially fill or flood a room. In embodiments having multiple LEDs, the LEDs are optionally grouped into one or more arrays. FIG. 2-1 is a perspective view of an illustrative transmitter LED array system 200. System 200 includes a first LED array 210 and a second LED array 220. Array 210 illustratively has a base plane 212 that positions LEDs 302, and array 220 has a base plane 222 that positions LEDs 302. Each array illustratively has a height 250 and a length 260. In the embodiment shown in FIG. 2-1, each array has two rows along height 250 and four columns along length 260. Or, in other words, each array is a 2 by 4 array. Embodiments of the present disclosure include any number of LEDs per a row and any number of LEDs per a column. Embodiments also include any number of arrays and any number of LEDs per an array.

FIG. 2-2 is a top down view of system 200. FIG. 2-2 shows that arrays 210 and 220 are illustratively angled away from each other (i.e. their LEDs point in different directions). Array 210 is rotated clockwise by an angle 280 and array 220 is illustratively rotated counterclockwise by an angle 290. Angles 280 and 290 may either be the same or different. In an embodiment, angles 280 and 290 are both between twenty to forty degrees. Embodiments are not however limited to any particular angles and embodiments include all angles. For instance, in another embodiment, LED arrays are angled toward each other as opposed to being angled away from each other as is shown in FIGS. 2-1 and 2-2.

It should be noted however that in multiple LED embodiments, that the placement or positioning of LEDs is not limited to arrays. Embodiments of the present disclosure include any arrangement of multiple LEDs. For example, LEDs are illustratively not placed in rows and columns, and are instead illustratively placed in other types of patterns (e.g. a starburst pattern). LEDs may also be placed in more or less randomly scattered positions.

LEDs 302 illustratively generate IR light along a path that is perpendicular or normal to their base planes (e.g. normal to base planes 212 and 222 in FIG. 2-1). LEDs 302 may also generate additional light. For example, in an embodiment for illustration purposes only and not by limitation, LEDs 302 generate light normal to their base plane and also generate a cone of light from plus thirty-five degrees from normal to minus thirty-five degrees from normal.

Returning to FIG. 1, transmitter 300 and receiver 400 are illustratively operated in spaces having a ceiling, a floor, and/or one or more walls. Transmitter 300 and receiver 400 are also illustratively operated in spaces having one or more objects between a transmitter 300 and a receiver 400. In such a case, at least some of the signals 12 generated by LEDs 302 are reflected off from surfaces of the ceiling, floor, walls, and/or objects. In such an embodiment, signals 12 take a variety of different paths in going from transmitter 300 to receiver 400. This may be advantageous over other systems such as those that require a direct line-of-sight. For instance, in a line-of-sight system, there may be only one signal path between a transmitter and a receiver. If the one path is obstructed, for example by a person walking between the transmitter and the receiver, the receiver will not receive the signal. However, in systems such as that shown in FIG. 1, signals 12 take multiple different paths in traveling from transmitter 300 to receiver 400. As long as all of the paths are not obstructed, the receiver will still receive a signal.

Embodiments of the present disclosure may also provide advantages over other systems such as those that use other types of transmission techniques. For instance, radio frequency (RF) waves could perhaps be used. Other transmission techniques such as RF waves may however travel through walls, ceilings, floors, etc. In environments having multiple wireless audio systems, such as in long or short term residential care facilities, this could lead to signal interference between systems in multiple rooms. This issue however is not present in systems utilizing LEDs. The light produced by LEDs is illustratively contained within the room where the light is generated. Thus, there is either no interference or reduced interference as compared to other potential systems such as those that use RF waves.

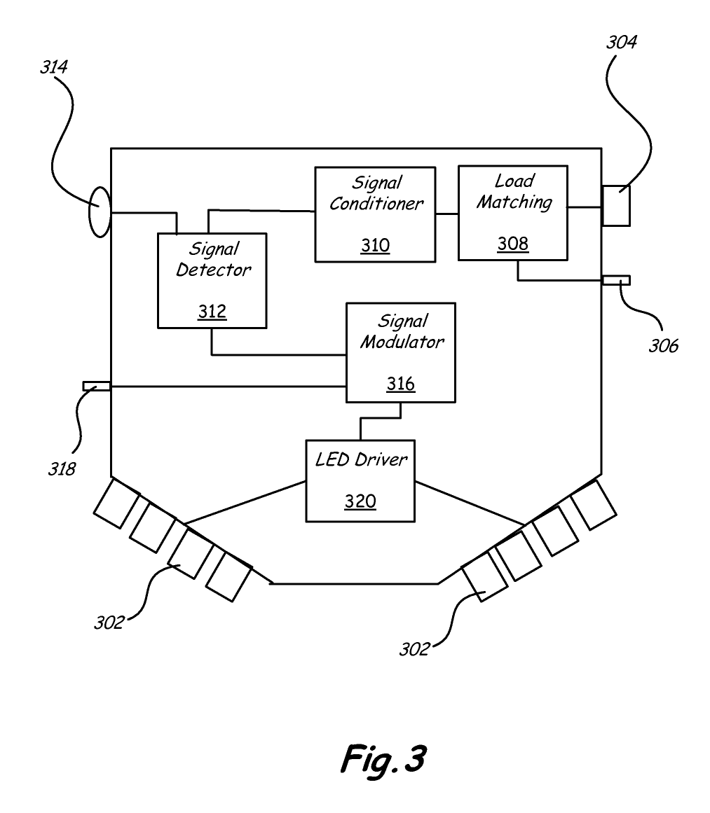

FIG. 3 is an illustrative block diagram of transmitter 300. Transmitter 300 includes an audio input connector 304 that receives an audio signal from audio source 10 in FIG. 1. Input connector 304 is illustratively configured to accommodate any type of audio input. In one embodiment, input connector 304 is illustratively a ⅛″ headphone jack and various types of audio sources 10 are connected to transmitter 300 utilizing an appropriate adapter. Transmitter 300 also includes an audio type selector 306. Selector 306 is illustratively adjusted by a user to correspond to the type of audio input being used by the transmitter. For example, if transmitter 300 is receiving an audio signal from a headphone line, selector 306 is adjusted to correspond to receiving input from a headphone line. Selector 306 is illustratively either manually controlled by a user or is self-sensing in that it automatically determines the type of audio source that is connected. Similar to connector 304, selector 306 is illustratively able to accommodate for any type of audio input.

The audio signal from input 304 is then passed to a load or impedance matching module 308. Module 308 receives the indication of the audio input type from selector 306. Module 308 illustratively converts various types of audio input signals such that it provides an equivalent signal to signal conditioner 310 regardless of the audio source. For instance, an audio signal from left and right RCA lines may have a different peak-to-peak voltage than an audio signal from a headphone line. Module 308 illustrative converts the signals such that they have the same peak-to-peak voltages. Or, in other words, module 308 normalizes different voltage amplitudes of incoming signals to maximize bandwidth. Signal conditioner 310 then filters the audio signal. Conditioner 310 illustratively has a high pass filter and a low pass filter. The high pass filter removes any high frequency noise from the signal, and the low pass filter removes low frequency signals such as direct current noise.

The audio signal is then passed to signal detector 312. Detector 312 determines if there is an audio signal being received from an audio source 10. For example, transmitter 300 may not be receiving a signal if audio source 10 is turned off. In one embodiment, detector 312 compares a voltage of the audio signal from conditioner 310 to a reference voltage. If detector 312 determines that an audio signal is not being received, transmitter 300 illustratively does not generate and transmit a wireless signal. This feature may be advantageous in that components of transmitter 300, such as but not limited to LEDs 302, may have a limited life time (i.e. they stop producing light after a certain amount of usage). By not generating a wireless signal when there is no audio signal, the lifetime and/or reliability of transmitter 300 may be improved. Additionally, not generating a wireless signal may also reduce power consumption.

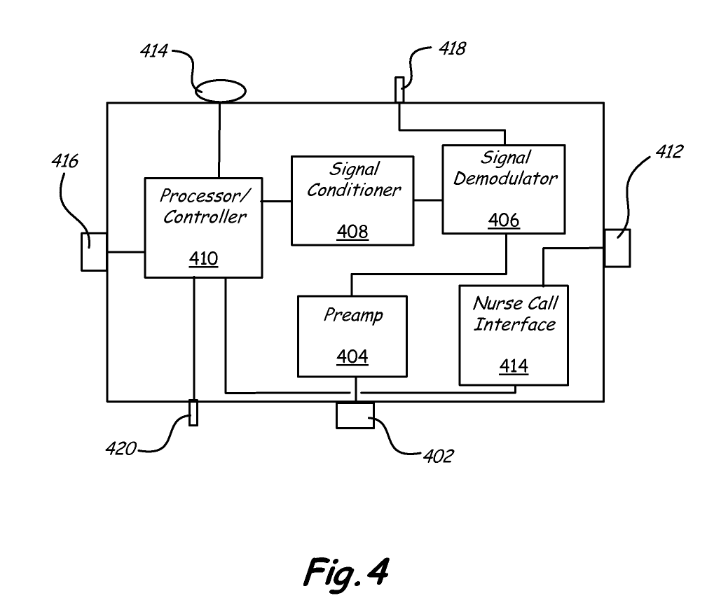

Signal detector 312 is optionally connected to an indicator light 314 (also shown in FIG. 1). Indicator light 314 illustratively indicates the status of transmitter 300. For example, in an embodiment, light 314 is off (i.e. no light is produced) when transmitter 300 is turned off or is not receiving power. Light 314 flashes (i.e. intermittently produces light) when transmitter 300 is turned on but is not generating and transmitting a signal, and light 314 is continuously on when transmitter 300 is generating and transmitting a wireless signal. Receiver 400 optionally has a corresponding indicator light 414 (shown in FIGS. 1 and 4). As will be discussed later in greater detail, lights 314 and 414 are illustratively useful in troubleshooting, setting-up, or operating wireless audio systems.

Following detector 312, the audio signal is passed to signal modulator 316. Modulator 316 converts the incoming audio signal into a signal that is used to produce the wireless signal. In an embodiment, the incoming audio signal is in the form of a varying voltage, and modulator 316 converts the varying voltage signal into a frequency based signal (i.e. a frequency modulated or FM signal). Modulator 316 illustratively includes a voltage-controlled oscillator that is utilized to produce the FM signal. In another embodiment, the incoming audio signal is converted into an amplitude modulated or AM signal. Embodiments of modulator 316 are not however limited to any specific methods or devices for modulating the incoming signal, and illustratively include any methods and/or devices.

Transmitter 300 optionally includes a channel or frequency center selector 318. Selector 318 is illustratively toggled or otherwise manipulated by a user to change the center frequency of the wireless signal produced by transmitter 300. For example, transmitter 300 may have two channels, a channel one and a channel two. Channel one may correspond to frequencies of 110 to 90 kHz with a center frequency of 100 kHz. Channel two may correspond to frequencies of 60 to 40 kHz with a center frequency of 50 kHz. As will be discussed later, receiver 400 optionally includes a corresponding channel or frequency selector 418 (shown in FIGS. 1 and 4). Selectors 318 and 418 allow for multiple wireless audio systems to be operated in one room. For instance, a first user in a room could use channel one, and a second user in the room could use channel two. This allows for the users to control and to listen to their own audio sources 10. If there were not multiple channels (e.g. multiple center frequencies), operating more than one audio system in a room may be difficult or impossible due to the wireless signals from the multiple audio systems interfering with each other. Although the previous example discussed an embodiment having two channels, embodiments are not limited to any particular number of channels and illustratively include any number of channels (e.g. 1, 2, 3, 4, 5, 6, etc.).

Following modulator 316, the signal, which is illustratively a frequency modulated signal, is passed to LED driver 320. Driver 320 powers and operates LEDs 302. LEDs 302 are illustratively powered on and off (i.e. alternated between producing light and not producing light) such that the modulated audio signal is reproduced or converted into a light based signal.

In an embodiment, LEDs 302 are infrared LEDs (i.e. they produce electromagnetic radiation having wavelengths from 750 nanometers to 100 micrometers). In one specific embodiment, LEDs 302 produce light having wavelengths of approximately 870 and/or 940 nanometers. Embodiments of LEDs are not however limited to those producing any particular wavelengths of light.

FIG. 4 is a block diagram of receiver 400. Receiver 400 includes a sensor 402. Sensor 402 illustratively converts the light based signal from transmitter 300 into an electrical signal. In one embodiment, for illustration purposes only and not by limitation, sensor 402 is a semiconductor based photodiode that converts light into electrical current. In FIG. 1, sensor 402 is shown as facing away from LEDs 302. This represents that sensor 402 illustratively indirectly receives a signal from transmitter 300 (i.e. it receives a signal that has been reflected off from one or more surfaces before reaching sensor 402).

The electrical signal produced by sensor 402 is then transmitted to preamplifier 404. Preamp 404 illustratively increases a voltage and/or current of the signal and passes it to signal demodulator 406. Demodulator 406 converts or transforms the incoming signal. The signal is illustratively converted such that it is the same or similar to the signal that enters signal modulator 316 in FIG. 3. For example, in an embodiment, modulator 316 converts a voltage based signal (i.e. a signal that communicates data based on voltage manipulation) to a frequency based signal. Demodulator 406 illustratively receives the frequency based signal from preamp 404 and converts it back into a voltage based signal.

As was previously mentioned, in an embodiment, receiver 400 includes a frequency center selector or channel selector 418. Selector 418 is illustratively toggled or otherwise manipulated by a user to select the frequency center being utilized by transmitter 300. In another embodiment, selector 418 is automated in that it self-senses an available transmission signal and selects the appropriate channel or frequency center. Selector 418 then sends an indication of the selected channel or center frequency to demodulator 406. In an embodiment, demodulator 406 includes a phase lock loop. The indication of the selected channel or center frequency is illustratively utilized in setting the frequency of the phase lock loop reference signal. Consequently, if the setting of selectors 318 and 418 are the same, demodulator 406 is able to convert the incoming signal. However, if the settings of selectors 318 and 418 are different, the incoming signal is outside of the phase lock loop's “capture range” and demodulator 406 is not able to convert the incoming signal. In rooms in which multiple audio systems are in use, this feature may be advantageous in that it allows an audio system user to selectively listen to one of possibly several wireless signals being transmitted in the room.

After the signal is demodulated, it is optionally passed to a signal conditioner 408. Conditioner 408 illustratively includes a high pass filter and a low pass filter to remove high frequency noise and direct current noise. The signal is then passed to a transmitter processor or controller 410.

As was previously mentioned, receiver 400 illustratively has an indicator light 414 that corresponds to transmitter indicator light 314. In an embodiment, indicator light 414 is communicatively coupled to and controlled by controller 410. For instance, when controller 410 detects an incoming audio signal, indicator light 414 is powered such that it is continually on. When controller 410 is powered on and it does not detect an incoming audio signal, light 414 is powered intermittently (i.e. light 414 is a blinking or flashing light). When controller 410 is turned off or is not receiving power, light 414 is turned off.

Transmitter indicator light 314 and receiver indicator light 414 may help in the operation, set-up, or troubleshooting of a wireless audio system. For instance, if a user is not hearing any sound from the audio system, the user can look at lights 314 and 414. If light 314 is off or blinking, no wireless signal is being transmitted so any troubleshooting efforts should be first spent on obtaining a solid, continuous light from light 314. However, if light 314 is continuously on and light 414 is off or blinking, this is an indication that a signal is being transmitted, but it is not being received by receiver 400. Accordingly, troubleshooting efforts should begin with examining possible issues with receiver 400.

Controller 410 is illustratively communicatively coupled to a nurse call station 50 (shown in FIG. 1) through a nurse call input connection point 412 and a nurse call interface 414. In a long-term or short-term care facility, a nurse call station 50 may be placed near a patient or resident bed or other location. Station 50 allows for a user to speak and listen to a remotely located person through speaker 52. A privacy light 58 is illustratively a red light that is turned on to indicate to a user that his or her speech may be heard by others.

Nurse call station 50 also illustratively includes a user input pad or buttons 56. User input 56 illustratively includes a button or other user input device that allows for a user to indicate that a nurse's attention is requested. User input 56 may also include other buttons or input devices. For example, user input 56 illustratively includes buttons to request for the attention of other persons or to request for specific services, such as but not limited to, requesting for pain medication or requesting for a nurse's assistant. After a user input 56 is selected, an acknowledgment light 60 is illustratively turned on by a remote user to acknowledge that they have received the request. User input 56 may also include environmental controls such as, but not limited to, controls for room lighting, heating, air conditioning, and raising or lowering a thermostat. Communications between station 50 and remote persons are illustratively facilitated through a communications connection 62. In an embodiment, connection 62 is a serial data bus that illustratively connects multiple nurse call stations to one or more centralized remote locations (e.g. a nurse's office).

Receiver 400 is also illustratively communicatively coupled to a pillow speaker 20 (shown in FIG. 1) through a pillow speaker connection point 416. Similar to nurse call station 50, pillow speaker 20 is commonly positioned near a resident or patient. In at least certain embodiments, pillow speaker 20 differs from nurse call station 50 in that nurse call station 50 is mounted such that it has a fixed position and pillow speaker 20 is moveable. Also, as will become clear shortly, pillow speaker 20 may also include additional features not included in nurse call station 50.

In an embodiment, pillow speaker 20 has a user input pad or buttons 26, a privacy light 28, and an acknowledgement light 30. These are illustratively the same or similar as nurse call station 50's user input pad 56, privacy light 58, and acknowledgement light 60, respectively. It should be noted however that pillow speaker 20 is not directly connected to a remote communications connection such as connection 62. Instead, remote communications through pillow speaker 20 are illustratively first passed through receiver 400 and then relayed through nurse call station 50 to remote communications connection 62.

As was previously mentioned, pillow speaker 20 also includes a speaker 22. Like nurse call station speaker 52, speaker 22 is also able to generate and transmit sounds such that a user can communicate with a remote speaker such as, but not limited to, a nurse. Speaker 52 also generates sound from the wireless signal received and demodulated by receiver 400. In an embodiment, if receiver 400 is receiving a signal from both the nurse call station and from a wireless signal, the signal from the nurse call station overrides the wireless signal such that the nurse call audio is produced by speaker 22. This illustratively allows for a person to listen to an audio source 10 such as a television while still being able to receive important information such as medical information from a nurse or other care provider. Additionally, pillow speaker 20 optionally includes a headphone jack 34. In an embodiment, a user may plug a headphone set into jack 34 and listen to the pillow speaker audio output through the headphone set instead of through speaker 22.

Pillow speaker 20 further includes an auxiliary user input pad or buttons 36. Pad 36 illustratively includes controls for operation of audio source 10. For instance, if audio source 10 is a television, pad 36 may include buttons for controlling the television channel and buttons for controlling the television volume (i.e. the volume of the sound coming from speaker 22 or through headphones connected to jack 34). Pad 36 may include additional buttons for operating other devices, such as but not limited to, lighting, heating and cooling, window blinds, and a radio.

Returning again to FIG. 4, receiver 400 further includes a volume control selector 420. A user illustratively utilizes selector 420 to select whether pillow speaker volume is to be controlled locally through receiver 400 or remotely through audio source 10. When selector 420 is positioned or otherwise manipulated to indicate that volume is to be controlled remotely, pillow speaker 20 transmits a signal to audio source 10 through pillow speaker transmitter 38 (shown in FIG. 1). When selector 420 indicates that volume is to be controlled locally, pillow speaker 20 does not transmit any signal to audio source 10. Instead, controller 410 or another component of receiver 400 (e.g. an amplifying component) increases or decreases the volume of the sound produced by pillow speaker 20.

It should be noted that the volume control system described in the previous paragraph is advantageous in that it allows for a wireless audio system to accommodate a number of different audio sources 10. For instance, some audio sources 10 may only provide an audio signal output that has a fixed volume. Other audio sources 10 may only provide an audio signal output having a variable volume. Audio systems having volume control selectors 420 are able to accommodate audio sources 10 having either type of output signal.

FIG. 1 shows that pillow speaker 20 is communicatively coupled to receiver 400 through a cable 40. In one embodiment, for illustration purposes only and not by limitation, cable 40 consists solely of six wires. Two of the six wires are an audio line and an audio return line that transfer audio information between pillow speaker 20 and receiver 400. The next two wires are a power line and a ground line that facilitate an electric current to flow through and power components of pillow speaker 20. The final two wires are for digital communications. In one embodiment, the final two wires are a two-wire serial data bus. The final two wires illustratively transfer all of the other information between pillow speaker 22 and receiver 400. For instance, they transfer information from receiver 400 to pillow speaker 20 to actuate lights 28 and 30, and they transfer information from pads 26 and 36 from pillow speaker 20 to receiver 400. In an embodiment that utilizes a six wire cable 40, receiver pillow speaker input connection point 416 illustratively has corresponding connection points that receive the six wire cable.

In another embodiment of cable 40, the audio return line and the power ground line are combined into one line, a power/audio common ground line. In this embodiment, cable 40 consists solely of five wires which further reduces the number of wires needed.

It should be noted that the five and six wire/line embodiments of cable 40 described above and the corresponding simplified pillow speaker interfaces 416 illustratively reduce costs and increase reliability over other systems that may use more wires. Traditional pillow speaker connection cables typically included many more wires. For example, conventional pillow speaker wires may have three wires for television controls, two wires for each indicator light (e.g. lights 28 and 30 in FIG. 1), and two wires for each switch (e.g. two wires for each of the several possible inputs for buttons 26 and 36 described above). This would often lead to cables such as cable 40 and interfaces such as interface 416 having sixteen to eighteen wires and connections points as opposed to the five or six described above.

To this point, embodiments of receivers 400 and nurse call stations 50 such as those shown in FIG. 1 have been described in the context of being two separate units. In another embodiment, receivers and nurse call stations are integrated together and built as one physical unit such that the one physical unit has the functionality of both receiver 400 and nurse call station 50. In such an embodiment, the five or six wire cable 40 from pillow speaker 20 illustratively connects to a five or six wire interface in the combined receiver and nurse call station. This combination of receiver and nurse call station may reduce costs over separate systems and may also have other benefits such as reduced floor space requirements.

As has been described above, certain embodiments of the present disclosure provide wireless audio systems that do not require a line-of-sight between a transmitter and a receiver. This is illustratively accomplished by reflecting one or more wireless signals such that they take an indirect path to reach the receiver. Additionally, some embodiments have arrays that create multiple wireless signals with multiple paths. If a path is obstructed, for example by a passing person or object, the receiver is still able to receive a signal so long as at least one of the paths is not obstructed. Furthermore, certain embodiments of the present disclosure illustratively provide additional beneficial features such as, but not limited to, indicator lights, signal detectors, channel selectors, and improved cable connections.

Finally, it is to be understood that even though numerous characteristics and advantages of various embodiments have been set forth in the foregoing description, together with details of the structure and function of various embodiments, this detailed description is illustrative only. Those skilled in the art will recognize that changes may be made in detail, especially in matters of structure and arrangements of parts within the principles of the present disclosure to the full extent indicated by the broad general meaning of the terms in which the appended claims are expressed.

What is claimed is:

1. A pillow speaker cable for communicatively coupling a pillow speaker to another device, the cable comprising:
a first wire and a second wire, the first and the second wires comprising a data bus for communicating data to and from the pillow speaker; and
a third wire and a fourth wire, the third wire being an audio line and the fourth line being an audio return line, the audio line and the audio return lines transmitting audio information to and from a speaker in the pillow speaker.

2. The pillow speaker cable of claim 1, further comprising:
a fifth line, the fifth line being a power line;
wherein the fourth wire is a common ground line acting as a power ground/audio return line; and
wherein the fourth and the fifth wires facilitate an electric current to flow through and power components of the pillow speaker.

3. The pillow speaker cable of claim 2, wherein the number of wires in the cable consists solely of the five wires, the five wires being the first wire, the second wire, the third wire, the fourth wire, and the fifth wire.

4. The pillow speaker cable of claim 1, further comprising:
a fifth wire and a sixth wire, the fifth wire being a power line and the sixth wire being a power ground line, the fifth and the sixth wires facilitating an electric current to flow through and power components of the pillow speaker.

5. The pillow speaker cable of claim 4, wherein the number of wires in the cable consists solely of the six wires, the six wires being the first wire, the second wire, the third wire, the fourth wire, the fifth wire, and the sixth wire.

6. The pillow speaker cable of claim 1, wherein the data bus is a two-wire serial data bus.

7. A method of communicatively coupling a pillow speaker to another device, the method comprising:
connecting the pillow speaker to the another device utilizing a cable, the cable comprising four wires, wherein two of the four wires comprises a data bus and wherein the other two of the four wires comprises and audio line and an audio return line.

8. The method of claim 7, wherein the cable further comprises a fifth wire and a sixth wire, the fifth and the sixth wires comprising a power line and a power ground line.

9. The method of claim 7, wherein the cable further comprises a fifth wire, the fifth wire being a power line, and wherein the audio return line acts as a common ground/audio return line, the common ground/audio return line working with the audio line to transmit sound to and from the pillow speaker, the common ground/audio return line working with the power line to flow electricity to and power components of the pillow speaker.

10. The method of claim 7, wherein the another device is a wireless receiver.

11. The method of claim 7, wherein the another device is a nurse call station.

12. The method of claim 7, wherein the data bus is a two-wire serial data bus.

13. A pillow speaker system comprising:
a pillow speaker having user input buttons, indicator lights, and a speaker, the speaker facilitating communication with a remote location; and
a second device communicatively coupled to the pillow speaker through a cable, the cable comprising a two-wire serial data bus.

14. The pillow speaker system of claim 13, wherein the cable comprises five wires, two of the five wires being the two-wire serial data bus, a third of the five wires being an audio line, a fourth of the five wires being a power line, and a fifth of the five wires being a power ground/audio return line.

15. The pillow speaker system of claim 13, wherein the cable comprises six wires, two of the six wires being the two-wire serial data bus, a next two of the six wires being an audio line and an audio return line, the final two of the six wires being a power line and a power ground line.

16. The pillow speaker system of claim 13, wherein the second device comprises a nurse call interface module.

17. The pillow speaker system of claim 16, wherein a nurse call station is communicatively coupled to the nurse call interface module.

18. The pillow speaker system of claim 17, wherein the nurse call station is communicatively coupled to the remote location.

19. The pillow speaker system of claim 13, wherein the second device is a wireless receiver.

20. The pillow speaker system of claim 13, wherein the second device is a combination wireless receiver and nurse call station.
